(19) United States
(12) Patent Application Publication
(10) Pub. No.: US 2025/0084677 A1
(43) Pub. Date: Mar. 13, 2025

(54) LOCKING ASSEMBLY

(71) Applicant: Rocket Security Devices, Inc., Lithia Springs, GA (US)

(72) Inventor: Nash Stephens, Douglasville, GA (US)

(73) Assignee: Rocket Security Devices, Inc., Lithia Springs, GA (US)

(21) Appl. No.: 18/830,051

(22) Filed: Sep. 10, 2024

Related U.S. Application Data
(60) Provisional application No. 63/582,086, filed on Sep. 12, 2023.

(51) Int. Cl. E05C 1/16

(52) U.S. Cl. CPC E05C 1/166; E05Y 2400/85; E05Y 2800/678

(57) ABSTRACT

A locking assembly having a bolt carrier and a bolt receiver is disclosed. The locking assembly may include a T-shaped bolt that engages with the bolt carrier and the bolt receiver to lock or unlock a door. The T-shaped bolt may slide between an engaged and disengaged position. The locking assembly may further include an access box that may move between a locked position and an unlocked position, and a cable configured to extend from a back side to a front side of the door via a door hole. The cable may include a first cable end that engages with the T-shaped bolt, and a second cable end that may be inserted and positioned in an access box interior portion. The second cable end may be pulled via the access box to slide the T-shaped bolt from the engaged position to the disengaged position.

### TECHNICAL FIELD

The present disclosure relates to a locking assembly, and more specifically to a locking assembly configured to secure an entry door from intruders.

### BACKGROUND

With the increase in active shooting and violent incident tragedies, there have been attempts to create devices to protect children and other individuals from violent incidents. Such devices are installed in homes, schools, businesses, etc. Examples of such devices include a steel rod (that may be pushed into a hole in the floor), electronic or magnetic locks (that may be only controlled by school administration), chains, ropes, belts, wooden wedges, steel cross bars, door barricades, and/or the like.

The conventional locking means described above have limitations. For instance, such devices may cause users to trip (i.e., trip hazards), may get entangled with wheelchairs, are sometimes too low to the floor to engage and disengage, are too heavy, require extensive training to operate, are complicated to employ, require ladders to reach, are difficult to install, require maintenance, are noisy to activate (which may alert an intruder to the children's location), have multiple parts to manage/use, require use of keys that may be lost/misplaced, etc. Further, use of some devices such as steel cross bars may be cumbersome and may make escaping from the room impossible.

Furthermore, the conventional locking devices may potentially entrap people during a fire event or with an active shooter inside a classroom with defenseless children, and may not allow the first responders to access inside of the classroom and rescue the people locked inside the classroom. Stated another way, the conventional locking devices may not allow the first responders to quickly unlock the door from outside when the door is locked from inside. In addition, some devices may not comply with Federal Regulations, ADA requirements, Fire Safety Regulations, State, County, and City Ordinances.

Thus, there is a need for a system that may overcome the challenges described above, and may comply with the required regulations.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a first locking assembly portion that is installed on an interior side/portion of an enclosure, in accordance with the present disclosure.

FIG. 2 depicts a second locking assembly portion, in a locked position, which is installed on an exterior side of an enclosure, in accordance with the present disclosure.

FIG. 3 depicts the second locking assembly portion of FIG. 2 in an unlocked position, in accordance with the present disclosure.

FIG. 4 depicts a use of the first locking assembly and the second locking assembly to lock a door in accordance with the present disclosure.

FIG. 5 depicts a portion of another locking assembly in accordance with the present disclosure.

### DETAILED DESCRIPTION

### Overview

The present disclosure is directed to a locking assembly that may be used to secure an entry door. The locking assembly may enable a first user (e.g., a teacher) to lock the door from inside an enclosure (e.g., a classroom) in case of emergency, and unlock the door from inside to move out of the enclosure (e.g., when the emergency abates). In addition, the locking assembly may enable a second user (e.g., a first responder, school administrator, or an authorized user) to unlock the door from outside the enclosure, when the door may have been locked by the first user.

The locking assembly may include one or more first components that may be mounted on the door (and/or a door frame) to lock or unlock the door from inside, and one or more second components that may be mounted on the door to unlock the door from outside. In some aspects, the first component(s) may include a bolt carrier that may be mounted on the door, a bolt receiver that may be mounted on the door frame, and a bolt (e.g., a “T-shaped” bolt) that may engage with the bolt receiver via the bolt carrier to lock the door from inside. The bolt may engage with the bolt carrier (and the bolt receiver) when the first user desires to lock the door from inside, and may disengage from the bolt carrier (and the bolt receiver) when the first user (or the second user) desires to unlock the door.

The second component(s) may include an access box that may be mounted on the door to unlock the door from outside. The access box may be a cuboidal-shaped lock box that may be configured to move between a locked position and an unlocked position. The access box may be unlocked by using an access code (e.g., a 4-digit code).

The locking assembly may further include a cable or a wire that may be configured to engage with the first component(s) and the second component(s). The cable may extend from the first component(s) to the second component(s) via a door hole. The cable may include a first cable loop at a first cable end and a second cable loop at a second cable end. The first cable loop may engage with the bolt and the second cable loop may engage with the access box, when the door may be locked from inside by using the first components(s).

To lock the door from inside, the first user may take out the bolt from a storage area (e.g., a teacher drawer), and may insert the bolt in the bolt receiver via the bolt carriage. The first user may then engage the first cable loop with the bolt, and may engage the second cable loop with an insert (e.g., a rubber grommet) that may be disposed in the door hole (e.g., in proximity to the first components). The first user may then push the second cable loop into the access box through the door hole and the rubber grommet. The rubber grommet secures the second cable loop in an access portion interior portion.

When the second user desires to unlock the door from outside, the second user may enter the access code to open the access box, and then pull the second cable loop towards the second user's body. When the second user pulls the second cable loop, the cable may slide the bolt to disengage from the bolt receiver (and/or the bolt carriage), thereby unlocking the door from outside. Since the access box may be unlocked by using the access code, the door may be unlocked only by an authorized user (who knows the access code) and may not be unlocked by any intruder or unauthorized person.

The present disclosure discloses a locking assembly that may allow the second user (or a “first responder”) to unlock the door from outside, quickly and easily. The locking assembly may operate without the use of electricity. Thus, the locking assembly may be used to lock/unlock even when there is no electricity. Further, the locking assembly may not be controlled from a remote location (e.g., to prevent an overpowered principal from being forced to unlock all the classrooms). Further, the locking assembly may lock the door quietly (without making any noise) to reduce the chance of getting the attention of an active shooter, and may lock the door easily in just a few seconds. No parts are attached to the door less than 10 inches from the finished floor to prevent a wheelchair from becoming entangled. No parts are installed on or near the floor, which could cause a trip hazard. Furthermore, the locking assembly can be easily engaged and disengaged with one hand, with no special knowledge, twisting, or effort needed to operate it. In addition, the locking assembly is inexpensive and requires less/low maintenance.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

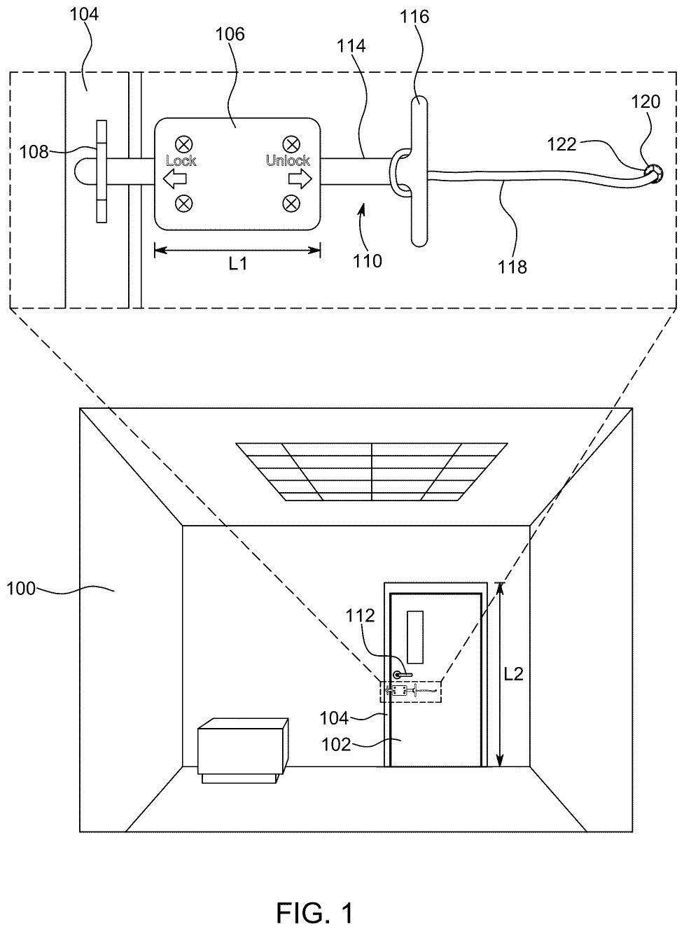

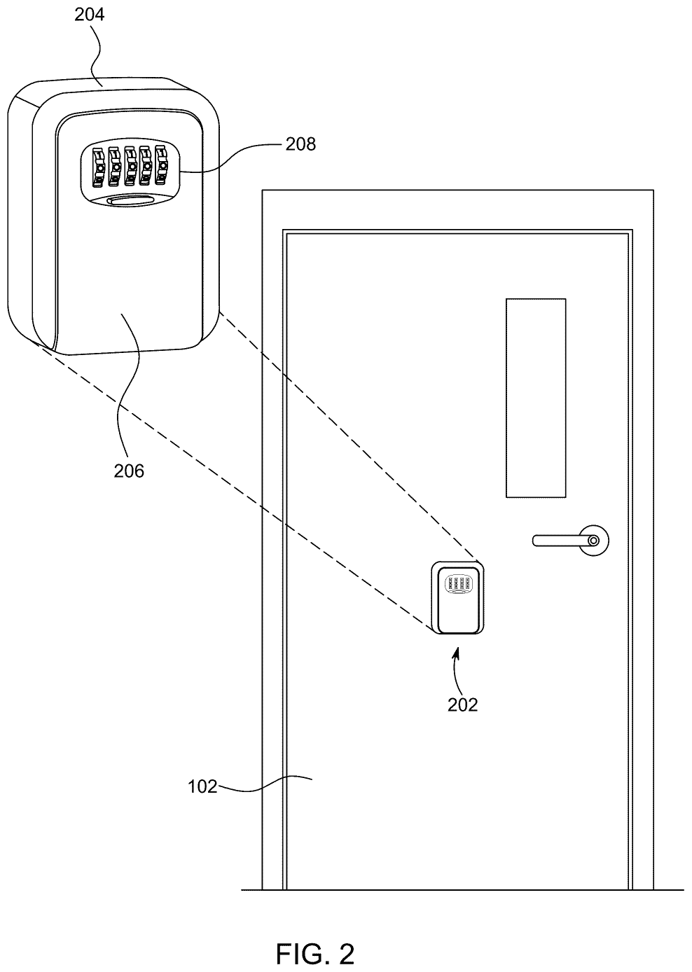

FIG. 1 depicts a first locking assembly portion that is installed on an interior side/portion of an enclosure 100, in accordance with the present disclosure. FIG. 1 will be described in conjunction with FIGS. 2, 3, and 4.

In some aspects, the enclosure 100 may be a classroom in a school. In alternative aspects, the enclosure 100 may be a room or a hall in a home, an office, etc. The enclosure 100 may include a door 102 that may separate the interior space/portion of the enclosure 100 from an exterior space (e.g., the area outside of the classroom). The door 102 may enable ingress into and egress from the enclosure 100. The door 102 may be installed on a door frame 104 that may be configured to support the door 102. In some aspects, the door 102 may be hinged at a door frame portion, and may be configured to pivotally or rotatably move between an open position and a closed position to enable users to access the enclosure interior portion. In alternative aspects, the door 102 may be configured to slide to move between the open position and the closed position. In the door open position, a user may enter (or exit from) the enclosure interior portion via the open door 102, and in the door closed position, the user may not enter (or exit from) the enclosure interior portion via the closed door 102.

In some aspects, the door 102 may be configured to be moved between a locked position and an unlocked position, via a locking assembly. Stated another way, the locking assembly may be used to lock or unlock the door 102. The door 102 may be locked at an edge opposite to the hinged edge of the door 102, via the locking assembly.

The locking assembly described above may include a first locking assembly portion (having one or more first components) and a second locking assembly portion (having one or more second components), disposed at opposites sides/surfaces of the door 102. The first locking assembly portion may be located/positioned at a door side/surface that faces the enclosure interior side/portion, and the second locking assembly portion may located/positioned at a door side/surface that faces the enclosure exterior side/portion. Specifically, the first locking assembly portion may be located/positioned at a first side of the door 102 (and the door frame 104) and the second locking assembly portion may be located/positioned at a second side of the door 102 (which may be opposite to the first side). In some aspects, the first side may face the enclosure interior side/portion, and the second side may face the enclosure exterior side/portion. For example, the first component(s) may be positioned on the door surface that faces the inside of the enclosure 100 (e.g., the classroom) and the second component(s) may be positioned on the door surface that faces the outside of the enclosure 100.

In some aspects, a first user (e.g., a teacher) may operate the first component(s) to lock the door 102 from inside the enclosure 100 to prevent an intruder entry into the enclosure 100. In addition, the first user may operate the first component(s) to unlock the door 102 from inside, when required. In further aspects, a second user (or an authorized person such as a school administrator) may operate the second component(s) to unlock the door 102 from outside the enclosure 100 (e.g., from outside the enclosure 100 to rescue people present inside the enclosure 100). The details of the first locking assembly portion and the second locking assembly portion are described below.

In some aspects, the first locking assembly portion may include a plurality of components including, but not limited to, a bolt carrier 106, a bolt receiver 108, and a bolt 110 (as shown in FIG. 1). The bolt carrier 106 may be installed/fastened on the door first side (that faces the enclosure interior side/portion), and may be configured to guide a bolt movement to secure or release the door 102 (or to lock/unlock the door 102). In some aspects, the bolt carrier 106 may include an interior channel (not shown) that may guide the bolt movement. The bolt carrier 106 may be of any shape and size. In an exemplary embodiment, the bolt carrier 106 may be cuboidal. In some aspects, the bolt carrier size may correspond to the bolt size. The bolt carrier 106 may be installed on the door 102 (or the door panel) by using fasteners (e.g., screws, nuts and bolts, etc.). When the bolt carrier 106 is installed on the door 102, a bolt carrier longitudinal axis “L1” may be perpendicular to a door longitudinal axis “L2”. In some aspects, the bolt carrier 106 may be installed on the door first side at a height of 34 inches to 48 inches from the floor/ground. Further, in some aspects, the bolt carrier 106 may be positioned below a door handle 112. In other aspects, the bolt carrier 106 may be positioned above the door handle 112. In yet another aspect, the bolt carrier 106 may be positioned parallel to the door handle 112.

The bolt receiver 108 may be fastened to the door frame 104 at a side that faces the enclosure interior side. In some aspects, the bolt receiver 108 may be mounted on a side jamb of the door frame 104 (as shown in FIG. 1). The bolt receiver 108 may work in conjunction with the bolt carrier 106 to secure or release the door 102 (i.e., to lock or unlock the door 102). The bolt receiver 108 may be aligned with the bolt carrier 106 to receive the bolt 110, via the bolt carrier 106. In other aspects (not shown), the bolt receiver 108 may be mounted on a head jamb of the door frame 104.

When the bolt 110 is positioned inside the bolt receiver 108, the door 102 may be in the locked position and may not enable the intruder entry from outside the enclosure 100 (as the door 102 is secured to the door frame 104). On the other hand, when the bolt 110 is not positioned inside the bolt receiver 108, the door 102 may be in the unlocked position, which may enable users to open the door 102 and enter or exit the enclosure 100 via the open door 102.

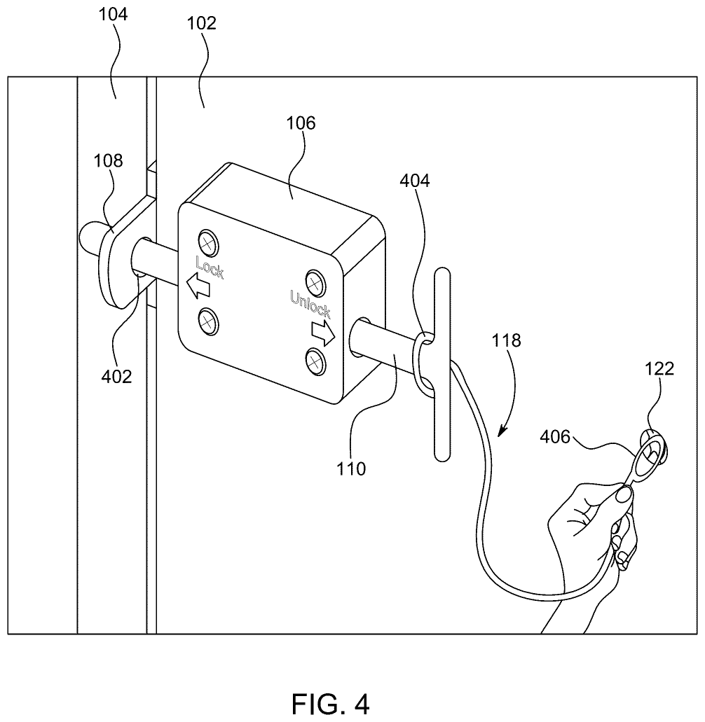

The bolt receiver 108 may be a door latch plate that may be mounted on the door frame 104 via one or more fasteners (e.g., screws). In some aspects, the bolt receiver 108 may include a plate and a “C-shaped” portion that includes a hole 402 (shown in FIG. 4) that may be configured to receive the bolt 110. The “C-shaped” portion may be disposed perpendicular to the plate. In some aspects, a hole diameter may correspond to a bolt diameter, so that the hole 402 may efficiently receive the bolt 110. The hole may receive the bolt 110 via the channel in the bolt carrier 106.

The bolt 110 may be a metal piece (e.g., a stainless steel piece, an aluminum piece, etc.) or a wooden piece that may be configured to engage with the bolt carrier 106 and the bolt receiver 108 to lock or unlock the door 102. The bolt 110 may be configured to move between an engaged position and a disengaged position. In the engaged position, the bolt 110 may engage with the bolt receiver 108 via the bolt carrier 106, to lock the door 102. Stated another way, in the engaged position, the bolt 110 may be inserted into the hole of the bolt receiver 108 through the bolt carrier 106. In the disengaged position, the bolt 110 may disengage from the bolt receiver 108 to unlock the door 102. Stated another way, in the disengaged position, the bolt 110 may not be inserted into the hole to keep the door 102 unlocked.

The bolt 110 may be of any shape and size. In an exemplary aspect, the bolt 110 may be a “T-shaped” bolt that may be configured to slide horizontally, parallel to a door plane to move between the engaged position (in which the bolt 110 engages with the bolt carrier 106 and the bolt receiver 108) and the disengaged position. In some aspects, the bolt 110 may slide perpendicular to the door longitudinal axis “L2” to move between the engaged position and the disengaged position, when the locking assembly is disposed on the door 102 in the arrangement/configuration shown in FIG. 1. In alternative aspects (not shown), the bolt 110 may be configured to slide vertically, parallel to the door longitudinal axis “L2” to move between the engaged position and the disengaged position, when the locking assembly is disposed in proximity to the head jamb of the door frame 104.

When the bolt 110 is T-shaped, the bolt 110 may include a first elongated portion 114 and a second elongated portion 116. In an exemplary aspect, both the first and second elongated portions 114, 116 may be elongated cylindrical structures, having a diameter in a range of 0.25 inches to 1 inch. The first elongated portion 114 may be positioned perpendicular to the second elongated portion 116. Stated another way, a first elongated portion longitudinal axis may be perpendicular to a second elongated portion longitudinal axis. In some aspects, the first elongated portion 114 may be connected to the second elongated portion 116 at a second elongated portion middle part to form the “T-shaped” bolt. The first elongated portion 114 may be connected to the second elongated portion 116 by using any conventional attaching means such as welding.

In some aspects, a first elongated portion length may be greater than a second elongated portion length. In the engaged position, the first elongated portion 114 may be inserted in the bolt carrier 106 and the bolt receiver 108, and the second elongated portion 116 may be located outside the bolt carrier 106 and the bolt receiver 108. In further aspects, the second elongated portion length is greater than a bolt carrier width, which prevents the second elongated portion 116 to move inside the bolt carrier 106 in the engaged position. Further, in the example aspect depicted in FIG. 1, the first elongated portion longitudinal axis is perpendicular to the door longitudinal axis “L2”, in the engaged position. In addition, in the engaged position, the bolt 110 may be positioned parallel to the door plane.

As described above, the locking assembly may further include the second locking assembly portion that may be installed on the door second side (which may be opposite to the first locking assembly portion installed on the door first side), which may not be seen by the users present inside the enclosure 100. The second locking assembly portion may include an access box 202 or a lock box (as shown in FIG. 2) fastened to the door second side, which may be used by a second user (e.g., a first responder, an authorized person, a school administrator, etc.) to open/unlock the door 102 from outside the enclosure 100, when the door 102 may be locked from inside by using the first locking assembly portion described above (i.e., when the bolt 110 is inserted into the bolt receiver 108, via the bolt carrier 106).

In some aspects, the access box 202 may be fastened to the door 102. The access box 202 may be made of any material and may have any size. For example, the access box 202 may be made of stainless steel or aluminum. In further aspects, the access box 202 may be installed at a height of 34 inches to 48 inches from the floor/ground surface. In some aspects, the access box 202 may be positioned at a height that may be the same as the height at which the bolt carrier 106 and the bolt receiver 108 may be positioned above the floor/ground surface. In alternative aspects, the access box 202 may be positioned at a height that may be different from the height at which the bolt carrier 106 and the bolt receiver 108 may be positioned above the floor/ground surface. For instance, the access box 202 may be installed at a greater height than the height at which the bolt carrier 106 and the bolt receiver 108 may be positioned above the floor/ground surface, and on the opposite side of the door 102 (as described above).

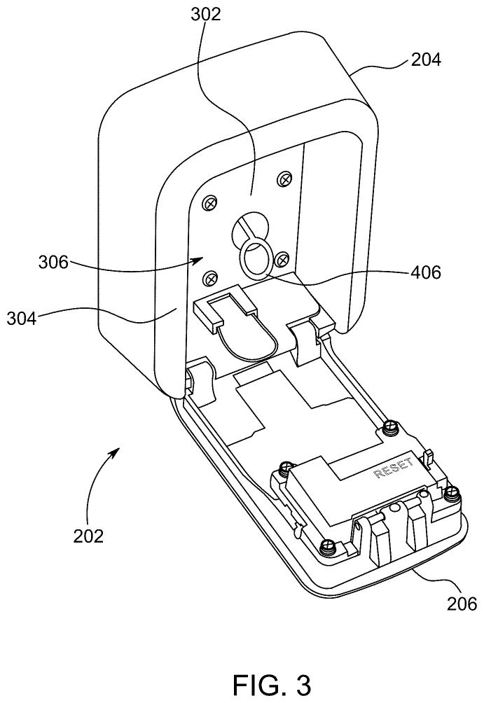

In an exemplary aspect, the access box 202 may be a cuboidal box having an access panel 204 and a box front door 206 (or a front cover). The access panel 204 may be installed on the door 102 (at the door second side) via one or more fasteners such as screws. Specifically, the access panel 204 may include a back wall 302 (as shown in FIG. 3) that may be installed on the door 102. The box front door 206 may be hinged at one edge of the access panel 204 (e.g., at a bottom edge of an access panel front wall 304), and may be configured to be locked at the other edge (e.g., at a top edge of the access panel front wall 304). In alternative aspects (not shown), the box front door 206 may be hinged at one of the access panel side wall, and may be locked at the other and opposite access panel side wall.

The access box 202 may be configured to move between a locked position (as shown in FIG. 2) and an unlocked position (as shown in FIG. 3). In the locked position, the box front door 206 may be closed and locked. In the unlocked position, the box front door 206 may not be locked (and may be opened by the second user). The access box 202 may be unlocked by using an access code. Stated another way, the access box 202 may be configured to move from the locked position to the unlocked position when the second user enters the access code on the access box 202.

In some aspects, the access box 202 may include a set of rotating dials 208 that may be used by the second user to enter the access code and open the access box 202. The set of rotating dials 208 may be located on a front surface of the box front door 206, which may be used by the second user to enter the access code and unlock the access box 202 (which may enable the second user to unlock the door 102 from outside the enclosure 100, as described later below). The set of rotating dials 208 may be used to receive the access code from the second user. The access code may be a sequence of digits, alphabets, or a combination thereof. In an exemplary aspect, the access code may be a 4-digit code. In alternative aspects (not shown), the access box 202 may include a keypad instead of the rotational dials 208 to move the access box 202 to the unlocked position. In some aspects, the access code may be a re-settable code that may be reset via the access box 202, via a code resetting mechanism. The access box 202 may include any other mechanism to move the access box 202 from the locked position to the unlocked position.

In further aspects, the locking assembly may include a cable 118 configured to extend from the door first side to the door second side, via a door hole 120, as shown in FIG. 1. The cable 118 may be configured to connect the first locking assembly portion and the second locking assembly portion. Specifically, the cable 118 may connect the bolt 110 to the access box 202.

The cable 118 may include a first end and a second end. The first end may include a first cable loop 404 and the second end may include a second cable loop 406 (as shown in FIG. 4). The first cable loop 404 and the second cable loop 406 may be a section of cable that forms a loop or a circle, in which items (e.g., the bolt 110 or a user finger) may be inserted or affixed. The cable 118 may have any length, and the first cable loop 404 and the second cable loop 406 may have any diameter. In some aspects, the diameters of the first cable loop 404 and the second cable loop 406 may be the same. In other aspects, the diameters of the first cable loop 404 and the second cable loop 406 may be different from each other. In an exemplary aspect, the diameters of the first cable loop 404 and the second cable loop 406 may be in a range of 0.8 to 1.2 inches.

In some aspects, the first cable loop 404 may be configured to engage with the bolt 110 and the second cable loop 406 may be configured to engage with the access box 202, as shown in FIGS. 3, and 4. Specifically, the second cable loop 406 may be configured to be inserted and positioned in an access box interior portion 306, when the bolt 110 may be in the engaged position (or when the door 102 is in the locked position via the first locking assembly portion). In some aspects, the second cable loop 406 may be inserted and positioned inside the access box interior portion 306 via an insert 122. The insert 122 may secure the second cable loop 406 in the access box interior portion 306, and prevent the second cable loop 406 to come out of the access box 202 through the door hole 120. The insert 122 may be made of any material and may be of any size. In an exemplary aspect, the insert 122 may be made of a rubberized material (e.g., be a rubber grommet that may be flexible) that may be positioned in the door hole 120. The insert 122 may be positioned in the door first side, as shown in FIG. 1. For instance, the insert 122 may be positioned in proximity to the first component(s). The insert 122 may be configured to be easily pressed/flexed and positioned in the door hole 120. When the insert 122 may be pushed into the door hole 120, the insert 122 may expand to secure the insert 122 in the door hole 120. The second cable loop 406 may be pushed into the access box 202 via the insert 122 to secure the second cable loop 406 in the access box interior portion 306. The insert 122 may be circular in shape and may have a diameter that corresponds to the door hole 120 diameter (e.g., a 0.75-inch hole). In an exemplary aspect, the insert diameter may be greater than the door hole 120 diameter.

In further aspects (not shown), the second cable loop 406 may include other attachments that may enable securing of the second cable loop 406 in the access box interior portion 306. For instance, the second cable loop 406 may include a “T-shaped” elastomeric member that may be easily pushed through the door hole 120 into the access box 202, and used to secure the second cable loop 406 in the access box interior portion 306. When the first user pushes the “T-shaped” elastomeric member into the access box 202 (via the door hole 120) and releases it, the “T-shaped” elastomeric member expands and then the “T-shaped” elastomeric member straightens out, which may enable the “T-shaped” elastomeric member to secure the second cable loop 406 (as the “T-shaped” elastomeric member may not be pulled back through the door hole 120 or may not fall back through the door 102). Further, in this configuration, the second cable loop 406 remains securely locked in the access box 202. In some aspects, the second cable loop 406 may be configured to be pulled via the access box 202 to slide/move the bolt 110 from the engaged position to the disengaged position, when the access box 202 is in the unlocked position, as described below.

In operation, when there is some emergency (e.g., an active shooting situation or when there is a possibility that an intruder might enter the enclosure 100 via the door 102), the first user (e.g., a teacher) may take out the bolt 110 and the cable 118 from a storage area (e.g., a teacher drawer, not shown). The first user may then insert the bolt 110 in the bolt carrier 106 and may slide the bolt 110 to move inside the bolt receiver 108 via the bolt carrier 106. Stated another way, the first user may position the bolt 110 in the engaged position. When the bolt 110 is in the engaged position, the door 102 may be locked and the intruder may not be able to enter from outside.

When the first user moves the bolt 110 in the engaged position, the first user may engage the first cable loop 404 to the bolt 110 and may push the second cable loop 406 through the door hole 120 into the access box 202 or in the access box interior portion 306 (e.g., via the back wall 302, as shown in FIG. 4). In some aspects, the first user may first engage the second cable loop 406 with the insert 122 (e.g., the rubber grommet) disposed in the door hole 120, and then push the second cable loop 406 into the access box interior portion 306 via the insert 122 and the door hole 120, to position/secure the second cable loop 406 in the access box interior portion 306.

When the second user (i.e., a first responder or an authorized user) arrives to rescue the users inside the enclosure 100, the second user may enter the access code on the access box 202 via the set of rotating dials 208. When the second user enters the correct access code, the access box 202 may move from the locked position to the unlocked position. The second user may then open the box front door 206 and may see the second cable loop 406 that may be engaged with the back wall 302 (as shown in FIG. 3). As described above, the second cable loop 406 may be secured by the insert 122. The second user may insert the second user's finger in the second cable loop 406 and may pull the second cable loop 406 towards the second user's body (i.e., pull the second cable loop away from the back wall 302).

When the second user pulls the second cable loop, the cable 118 may pull the bolt 110 and may move the bolt 110 from the engaged position to the disengaged position. Specifically, when the second user pulls the second cable loop 406, the first cable loop 404 may pull the bolt 110 horizontally in a direction away from the bolt receiver 108, to move the bolt 110 away from the bolt receiver 108 so that the bolt 110 may move to the disengaged position. When the bolt 110 moves to the disengaged position, the second user may open the door 102 and may enter the enclosure 100. The first user may then take out the bolt 110 and the cable 118 and place them back in the storage area. Thus, the second user may easily unlock the door 102 without using any key or any specialized tool.

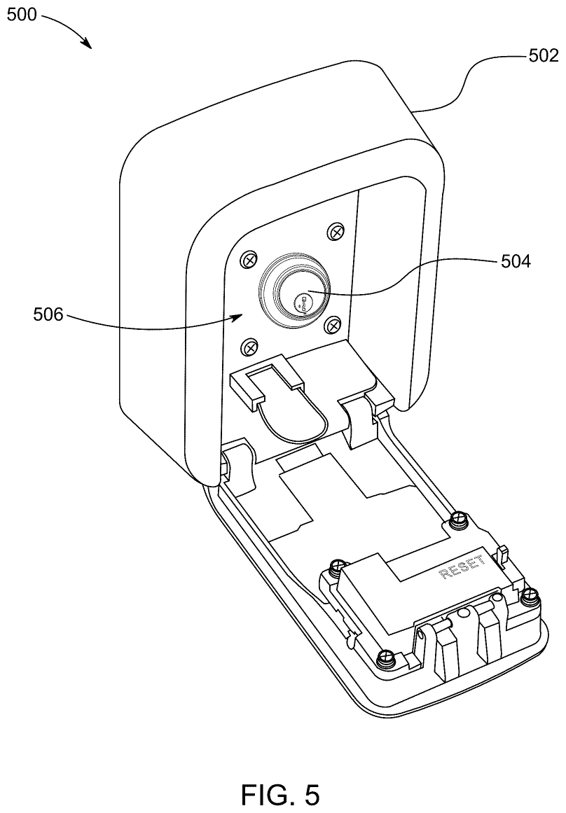

FIG. 5 depicts a portion 500 of another locking assembly in accordance with the present disclosure. Specifically, FIG. 5 depicts an access box 502 of the locking assembly that may be installed on the door second side, which may be accessed by the second user located outside the enclosure 100. The access box 502 may be similar to the access box 202 described above. The access box 502 may be configured to move between the locked position and the unlocked position, as described above.

In some aspects, the locking assembly of FIG. 5 may include a deadbolt 504 that may be located in an access box interior portion 506. In some aspects, the access box 502 may include a large hole (e.g., 2.5 inches hole) at an access box backwall, which may be configured to engage the deadbolt 504. The deadbolt 504 may be used to unlock the door 102 from outside. In some aspects, the second user may enter the access code in the access box 502 to move the access box 502 to the unlocked position. When the access box 502 is in the unlocked position, the second user may operate the deadbolt 504 (e.g., by using a key or a lock handle) to unlock the door 102 from outside. In some aspects, the key may be stored in the access box interior portion 506 to easily manage the key (without misplacing the key).

In some aspects, the second cable loop (not shown in FIG. 5) may engage with the deadbolt 504. When the second user turns the deadbolt 504, the cable 118 may pull the bolt 110 and move the bolt 110 from the engaged position to the disengaged position (to unlock the door 102 from outside). In alternative aspects, the locking assembly of FIG. 5 may not include the first locking assembly portion described above, and the deadbolt 504 may engage with a latch (or a standard locking/unlocking handle) positioned on the door first side (or located inside the enclosure 100). In this case, when the user operates the deadbolt 504, the latch may move from inside and unlock the door 102.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A locking assembly comprising:
a bolt carrier fastened to a first side of a door;
a bolt receiver fastened to a door frame;
a T-shaped bolt configured to engage with the bolt carrier and the bolt receiver to lock or unlock the door, wherein the T-shaped bolt is configured to slide between an engaged position and a disengaged position;
an access box fastened to a second side of the door, wherein the access box is configured to move between a locked position and an unlocked position; and
a cable configured to extend from the first side to the second side via a door hole, wherein the cable comprises a first cable end and a second cable end, wherein the first cable end is configured to engage with the T-shaped bolt and the second cable end is configured to be inserted and positioned in an access box interior portion, and
wherein the second cable end is configured to be pulled via the access box to slide the T-shaped bolt from the engaged position to the disengaged position.

2. The locking assembly of claim 1, wherein the first side faces an interior portion of an enclosure, and the second side is disposed opposite to the first side.

3. The locking assembly of claim 1, wherein the access box is a lock box configured to move to the unlocked position via an access code.

4. The locking assembly of claim 3, wherein the lock box comprises a set of rotating dials configured to receive the access code.

5. The locking assembly of claim 3, wherein the second cable end is configured to be pulled via the access box when the lock box is in the unlocked position.

6. The locking assembly of claim 1, wherein the T-shaped bolt is configured to slide parallel to a door plane to engage with the bolt carrier and the bolt receiver.

7. The locking assembly of claim 1, wherein the first cable end comprises a first cable loop and the second cable end comprises a second cable loop.

8. The locking assembly of claim 7, wherein the first cable loop is configured to engage with the T-shaped bolt.

9. The locking assembly of claim 8, wherein the second cable loop is engaged with a rubber grommet.

10. The locking assembly of claim 9, wherein the rubber grommet is configured to be positioned in the door hole.

11. The locking assembly of claim 10, wherein a rubber grommet diameter is greater than a door hole diameter.

12. The locking assembly of claim 1, wherein:
the T-shaped bolt engages with the bolt receiver via the bolt carrier to lock the door, in the engaged position, and
the T-shaped bolt disengages with the bolt receiver to unlock the door, in the disengaged position.

13. The locking assembly of claim 12, wherein the T-shaped bolt comprises a first elongated portion and a second elongated portion, wherein the second elongated portion is positioned perpendicular to the first elongated portion, and wherein a first elongated portion length is greater than a second elongated portion length.

14. The locking assembly of claim 13, wherein in the engaged position, the first elongated portion is inserted in the bolt carrier and the bolt receiver and the second elongated portion is located outside the bolt carrier and the bolt receiver.

15. The locking assembly of claim 13, wherein in the engaged position, a first elongated portion longitudinal axis is perpendicular to a door longitudinal axis.

16. A locking assembly comprising:
a bolt carrier fastened to a first side of a door;
a bolt receiver fastened to a door frame;
a T-shaped bolt configured to engage with the bolt carrier and the bolt receiver to lock or unlock the door, wherein the T-shaped bolt is configured to slide between an engaged position and a disengaged position;
an access box fastened to a second side of the door, wherein the access box is configured to move between a locked position and an unlocked position; and
a cable configured to extend from the first side to the second side via a door hole, wherein:
the cable comprises a first cable end and a second cable end,
the first cable end is configured to engage with the T-shaped bolt and the second cable end is configured to be inserted and positioned in an access box interior portion,
the second cable end is engaged with a rubber grommet and positioned in the access box interior portion, and
the second cable end is configured to be pulled via the access box to slide the T-shaped bolt from the engaged position to the disengaged position.

17. The locking assembly of claim 16, wherein the first side faces an interior portion of an enclosure, and the second side is disposed opposite to the first side.

18. The locking assembly of claim 16, wherein the access box is a lock box configured to move to the unlocked position via an access code.

19. The locking assembly of claim 18, wherein the second cable end is configured to be pulled via the access box when the lock box is in the unlocked position.

20. A locking assembly comprising:
a bolt carrier fastened to a first side of a door;
a bolt receiver fastened to a door frame;
a T-shaped bolt configured to engage with the bolt carrier and the bolt receiver to lock or unlock the door, wherein the T-shaped bolt is configured to slide between an engaged position and a disengaged position, wherein the T-shaped bolt comprises a first elongated portion and a second elongated portion, and wherein the second elongated portion is positioned perpendicular to the first elongated portion;
an access box fastened to a second side of the door, wherein the access box is configured to move between a locked position and an unlocked position; and
a cable configured to extend from the first side to the second side via a door hole, wherein the cable comprises a first cable end and a second cable end, wherein the first cable end is configured to engage with the T-shaped bolt and the second cable end is configured to be inserted and positioned in an access box interior portion, and
wherein the second cable end is configured to be pulled via the access box to slide the T-shaped bolt from the engaged position to the disengaged position, wherein in the engaged position, the first elongated portion is inserted in the bolt carrier and the bolt receiver and the second elongated portion is located outside the bolt carrier and the bolt receiver, and wherein in the engaged position, a first elongated portion longitudinal axis is perpendicular to a door longitudinal axis.
